(19) United States
(12) Patent Application Publication
(10) Pub. No.: US 2012/0285307 A1
(43) Pub. Date: Nov. 15, 2012

(54) FLYING SAW

(75) Inventor: Hans-Joerg BRAUN, Hagen (DE)

(73) Assignee: REIKA GMBH & CO. KG., Hagen (DE)

(21) Appl. No.: 13/424,809

(22) Filed: Mar. 20, 2012

(30) Foreign Application Priority Data
May 12, 2011 (EP) 11003942.7

(51) Int. Cl. B23D 25/04; B26D 7/18; B26D 1/60

(52) U.S. Cl. 83/109; 83/284

(57) ABSTRACT

A flying saw has at least one guide rail, on which a saw apparatus is mounted so as to be movable along profile or pipe material to be cut to predetermined lengths, by way of at least one travel drive, particularly synchronous to the advancing movement of the profile or pipe material during cutting. The at least one guide rail as well as the travel drive are disposed above the saw apparatus, and no machine bed is present.

### CROSS REFERENCE TO RELATED APPLICATIONS

Applicant claims priority under 35 U.S.C. §119 of European Application No. 11003942.7 filed on May 12, 2011, the disclosure of which is incorporated by reference.

### BACKGROUND OF THE INVENTION

1. Field of the Invention

The invention relates to a flying saw having at least one guide rail, on which a saw apparatus is mounted so as to be displaceable along profile or pipe material to be cut to predetermined lengths, by way of at least one travel drive, particularly synchronous to the advancing movement of the profile or pipe material during cutting.

2. The Prior Art

So-called flying saws, which are synchronized with the advance of the profile or pipe section and undertake the cutting process in accordance with the advance of the profile or pipe section, are used for cutting profiles or pipe sections welded along a longitudinal seam, having a diameter of more than 100 mm, which sections are theoretically endless. Such flying saws, as they are known, for example, from German Patent Application No. DE 31 12 519 A1, comprise a saw apparatus that is disposed so as to be movable within a machine bed. For this purpose, guide and drive elements are disposed in the machine bed. Generally, a rack and pinion drive is disposed in the machine bed to move the saw apparatus along the machine bed.

It is a disadvantage of the previously known flying saws that the production of the machine bed becomes very complicated. Furthermore, the rack and pinion drive is exposed to contamination by chips washed in with the cooling fluid.

### SUMMARY OF THE INVENTION

It is therefore an object of the present invention to create a flying saw that can be produced with minimized effort, and in which contamination of the drive by cooling fluid and chips is avoided. According to the invention, this task is accomplished by a flying saw having at least one guide rail, on which a saw apparatus is mounted so as to be displaceable along profile or pipe material to be cut to predetermined lengths, by way of at least one travel drive, particularly synchronous to the advancing movement of the profile or pipe material during cutting. The at least one guide rail as well the travel drive are disposed above the saw apparatus, wherein in particular, no machine bed is present.

With the invention, a flying saw is created that can be produced with minimized effort and in which contamination of the drive by cooling fluid and chips is avoided. By means of the placement of the at least one guide rail as well as of the travel drive'above the saw apparatus, contamination of the drive by cooling fluid and chips is counteracted. Complicated production of a machine bed is eliminated.

In a further development of the invention, two guide rails are provided, which accommodate at least one transverse support that can be displaced on them, thereby forming a portal on which the saw apparatus is attached. In this way, reliable suspension of the saw apparatus is achieved. In this connection, it is advantageous if a frame element for accommodating the saw apparatus is formed on the at least one transverse support.

In an embodiment of the invention, the saw apparatus can be moved horizontally along the at least one transverse support and/or vertically along an orthogonal to the at least one transverse support, by way of at least one drive. In this way, optimal setting of the saw apparatus relative to the rod or pipe material to be cut to length is made possible.

In a further embodiment of the invention, the at least one drive comprises a spindle drive. In this way, precise adjustment of the saw apparatus is made possible.

In a further development of the invention, at least one vertical guide is present within the frame element, by way of which guide the saw apparatus is connected with the frame element. In this way, guided vertical movement of the saw apparatus within the frame element is made possible.

In a further embodiment of the invention, the saw apparatus is releasably connected with the frame element. In this way, simple replacement of the saw apparatus is made possible. Preferably, the releasable connection is formed with a threaded spindle disposed within the frame element for vertical movement of the saw apparatus. In this way, simple threading of the saw apparatus out of and into vertical guide rails advantageously disposed laterally in the frame element is made possible.

In a further embodiment of the invention, the saw apparatus is formed by a whirling cutting apparatus. In this way, an effective cutting process for cutting profile or pipe material to length is made possible. Furthermore, such a whirling cutting apparatus can be implemented in a compact construction, thereby making it possible to reduce centrifugal forces and to optimize acceleration processes.

In a further embodiment of the invention, the at least one drive comprises a servomotor. In this way, precise setting of the saw apparatus against the rod or pipe material to be cut to length is made possible.

In a further embodiment of the invention, the at least one travel drive is a rack and pinion drive, whereby a rack of the rack and pinion drive is disposed parallel to at least one guide rail. In this way, uniform drive of the transverse support that accommodates the saw apparatus is made possible. Lateral adjustment of the saw apparatus on the basis of non-uniform drive is thereby prevented. It is advantageous if a rack of the rack and pinion drive is disposed parallel to every guide rail.

In an advantageous embodiment of the invention, the at least one travel drive is an electromagnetic levitation drive. Here, the transverse support is configured on the portal in the manner of an electromagnetic levitation system, in which the attraction forces of electromagnets and permanent magnets bring about support and guidance of the transverse support on the two guide rails in known manner. In this way, friction forces are minimized, thereby making it possible to implement great accelerations of the saw apparatus along the rod or pipe material to be cut to length.

It is advantageous if a chip conveying device is disposed underneath the at least one saw apparatus. In this way, regulated return of cooling fluid and chips for subsequent recycling is made possible.

In a further development of the invention, at least one clamping module for accommodating a profile or pipe material to be cut to length is provided, which module is connected with the transverse support and can be set against the saw apparatus. In this way, a modular structure is achieved, in which the clamping module can be moved or replaced independent of the saw apparatus, thereby improving accessibility to the saw tool, for example, and facilitating its replacement due to wear. It is advantageous if such a clamping module is provided on both sides of the saw module, in the direction of the sections. The pipe material to be cut to length can thereby be fixed in place on both sides of the saw tool, in the clamping modules. In this case, it is possible to set the clamping modules very close to the saw tool, thereby making it possible to reduce vibrations during the sawing process.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows the schematic representation of a flying saw having two saw apparatuses, in a top view;

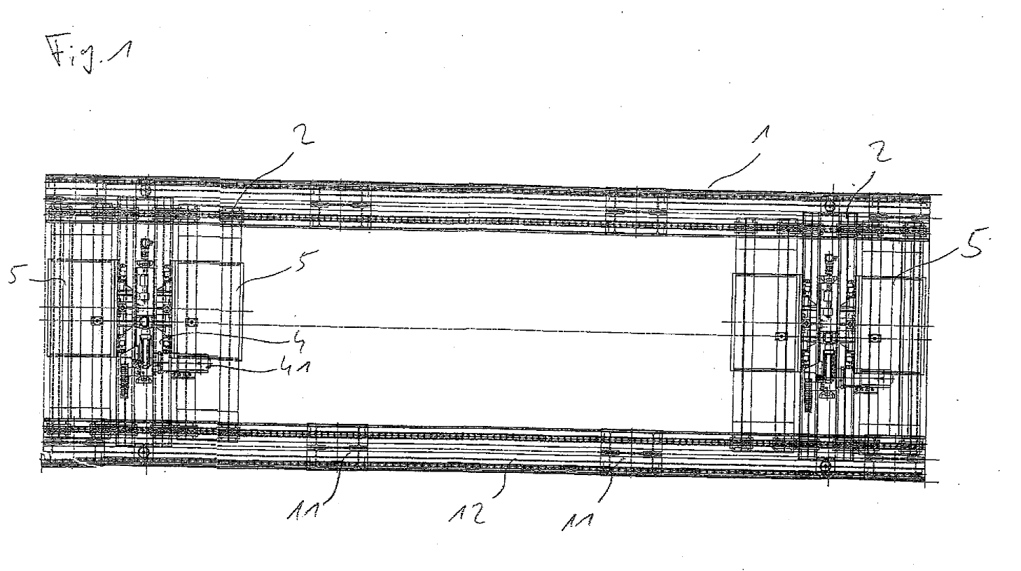

FIG. 2 shows the schematic representation of a saw apparatus of the flying saw from FIG. 1;

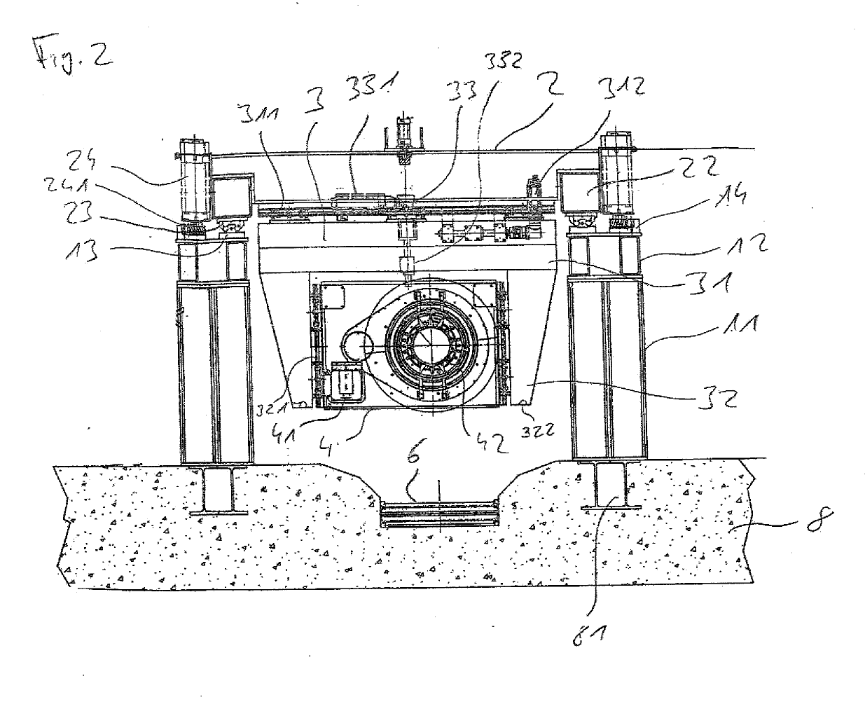

FIG. 3 shows the schematic representation of the saw apparatus from FIG. 2 in the side view, and

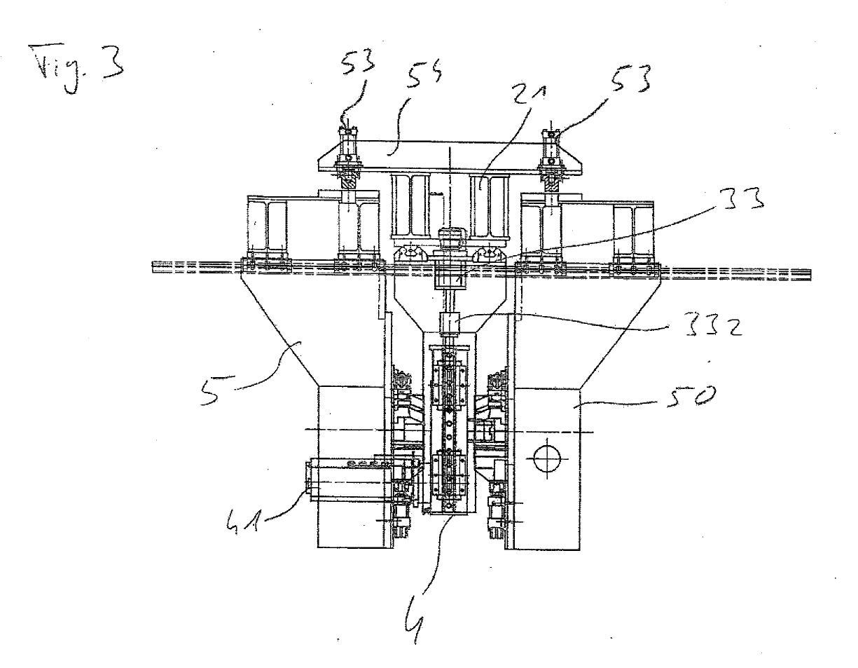

FIG. 4 shows the schematic representation of a clamping module of the saw apparatus from FIG. 1.

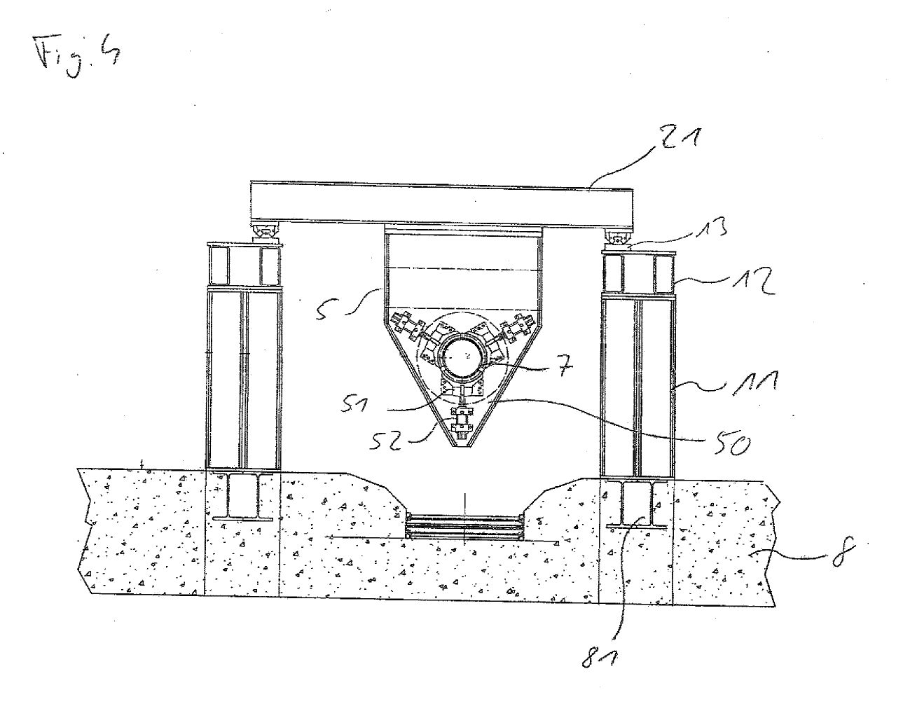

### DETAILED DESCRIPTION OF THE PREFERRED EMBODIMENT

Referring now in detail to the drawings, the flying saw selected as the exemplary embodiment essentially consists of a rail system 1 on which a transverse support 2 is disposed in displaceable manner, which support accommodates an interchange frame 3 for accommodating a whirling cutting apparatus 4. A clamping module 5 for clamping profile or pipe material to be cut in place is disposed on both sides of the whirling cutting apparatus 4. A chip conveyor 6 for carrying away chips and cooling fluid is disposed underneath the whirling cutting apparatus 4.

The rail system 1 is formed from pillars 11 disposed parallel to one another, on which two supports 12, disposed parallel to one another, are attached. In the exemplary embodiment, the pillars 11 are screwed to a support profile 81 that is cast into a foundation 8. A rail 13 for displaceable contact of the transverse supports 2 is disposed along each of the supports 12, on them. A pinion rack 14 is disposed on each support 12, on the outside, parallel to the rails 13.

In the exemplary embodiment, the transverse supports 2 are formed by two supports 21 disposed transverse to the supports 12, which are connected with one another by way of two profiles 22 disposed along the supports 12, so that a rectangular frame is formed. A guide 23 for engagement with the rails 13 of the rail system 1 is disposed underneath each of the profiles 22, on them. A servo-drive 24 is disposed at the two ends of a support 21, the drive axle of which is provided with a gear wheel 241, which engages into a pinion rack 14 of the rail system. The transverse supports 2 can be moved along the rails 13 of the rail system 1 by way of the servo-drives 24. In the exemplary embodiment, the transverse supports 2 are configured identically for the whirling cutting apparatuses and for the clamping modules 5.

An interchange frame 3 is attached to two transverse supports 2 by way of horizontal guide rails 311. The interchange frame 3 is formed by a support framework 31 on which two lateral supports 32 are disposed opposite one another. In this connection, the support framework 31 is connected with a horizontal linear drive 312, by way of which horizontal movement of the interchange frame 3 relative to the transverse supports 2 is made possible. Vertical lateral guides 321 for displaceable accommodation of the whirling cutting apparatus 4 are disposed on the lateral supports 32, on their sides that face the lateral support 32 disposed to lie opposite. Furthermore, a spindle 33 is disposed on the support framework 31, which spindle can be driven by way of a spindle drive 331 and is connected with the whirling cutting apparatus 4 by way of a coupling 332. In the exemplary embodiment, the coupling 332 is configured so that it can be locked and unlocked hydraulically. The whirling cutting apparatus 4 can be shifted along the vertical lateral guides 321, along the lateral supports 32, by way of the spindle 33.

Whirling cutting apparatuses for cutting pipe-shaped and rod-shaped work pieces are known, for example, from European Patent No. EP 490 328 B1. A whirling method is a chip-removing method in which the tool moves around the work piece in the manner of a spiral whirl. The cutting depth is produced by one or more blades that circulate at high cutting speed, in a single work step. In this connection, the inner mantle surface formed by the cutting tool rolls on the cylindrical outer mantle surface of the work piece to be machined. This movement process is superimposed on the constantly circulating movement of the cutting tool. The whirling method has the advantage that a plurality of cutting tools, particularly cutting blades, can be disposed next to one another and stand in engagement with the work piece at the same time, over a greater segment region. In this connection, during whirling cutting, a whirling saw tool having teeth that lie on the inside is used. The cutting teeth of the whirling tool having teeth on the inside can penetrate into the work piece tangentially. Because of the whirling method, the effective penetration radius of the whirling tool only has to comprise the wall thickness of the work piece. If this involves solid material, the whirling tool only has to penetrate to the center point of the solid material, because the other half of the work piece is cut off by means of the circular movement of the whirling tool. The whirling cutting apparatus 4 has an integrated drive 41. In the exemplary embodiment, the drive is configured as an electromagnetic rotational direct drive.

In the exemplary embodiment, positioning bores 332 are furthermore disposed at the free ends of the lateral supports 32. The positioning bores 332 serve for precise positioning of a displaceable lifting apparatus—not shown—that is provided with lateral guides that correspond with the lateral guides 321 of the lateral supports in the set-on position, in such a manner that the whirling cutting apparatus 4 can be moved into the lateral guides of the lifting apparatus by way of the spindle 33, and can subsequently be uncoupled from the spindle. Simple replacement of the whirling cutting apparatus 4 is made possible by means of such a lifting apparatus. For positioning, positioning aids disposed on the lifting apparatus are introduced into the positioning bores, so that a precisely positioned connection between lifting apparatus and the lateral supports is achieved. For simplification of the threading process, positioning bores and positioning pins can also be configured to be conical.

A clamping module 5 for clamping the profile or pipe material to be cut to length in place is disposed on both sides of the whirling tool 42 accommodated by the whirling cutting apparatus 4, on each of two transverse supports 2. The clamping module 5 is formed by a console 50 connected with the transverse supports 2, which console accommodates three clamping jaws 51 disposed offset by 120° from each other, which jaws can be pressed against a pipe 7 to be clamped in place, by way of hydraulic cylinders 52. Furthermore, a roll guide—not shown—is provided as a seat for the rod or pipe material to be cut to length. The roll guide—not shown—essentially comprises conical rolls that are set against one another, on which the rod or pipe material to be cut to length is disposed in a displaceable manner. The clamping modules 5 are releasably connected with two transverse struts 54, by way of hydraulic locking mechanisms 53, which struts are attached on the two transverse supports 2 that accommodate the interchange frame 3. The clamping modules 5 can be released from the transverse struts 54 by means of hydraulic unlocking, and displaced separately along the rails 13 of the rail system 1. In the exemplary embodiment, the clamping modules 5 are configured to be identical and are disposed on both sides of the whirling cutting apparatus, as mirror images of one another.

Accordingly, while only a few embodiments of the present invention have been shown and described, it is obvious that many changes and modifications may be made thereunto without departing from the spirit and scope of the invention.

What is claimed is:

1. A flying saw comprising:
at least one guide rail, on which a saw apparatus is mounted so as to be displaceable along profile or pipe material to be cut to predetermined lengths;
a travel drive for displacing the saw apparatus synchronous to an advancing movement of the profile or pipe material during cutting,
wherein the at least one guide rail as well the travel drive are disposed above the saw apparatus and no machine bed is present.

2. The flying saw according to claim 1, wherein there are two of said guide rails, said guide rails accommodating at least one transverse support adapted to be displaced on said guide rails to form a portal on which the saw apparatus is attached.

3. The flying saw according to claim 2, further comprising a frame element for accommodating the saw apparatus, said frame element being formed on the at least one transverse support.

4. The flying saw according to claim 3, wherein the saw apparatus is adapted to be moved horizontally along the at least one transverse support or vertically along an orthogonal to the at least one transverse support, by way of at least one drive.

5. The flying saw according to claim 4, wherein the at one drive comprises a spindle drive.

6. The flying saw according to claim 4, wherein at least one vertical guide is present within the frame element, and wherein the saw apparatus is connected with the frame element via said guide.

7. The flying saw according to claim 3, wherein the saw apparatus is releasably connected with the frame element.

8. The flying saw according to claim 1, wherein the saw apparatus is formed by a whirling cutting apparatus.

9. The flying saw according to claim 1, wherein the at least one travel drive comprises a servomotor.

10. The flying saw according to claim 1 wherein the at least one travel drive is a rack and pinion drive, wherein a rack of the rack and pinion drive is disposed parallel to said at least one guide rail.

11. The flying saw according to claim 11, wherein there are two guide rails and wherein the rack is disposed parallel to both of the guide rails.

12. The flying saw according to claim 1, wherein the at least one travel drive is an electromagnetic levitation drive.

13. The flying saw according to claim 1, further comprising a chip conveying device disposed underneath the at least one saw apparatus.

14. The flying saw according to claim 2, further comprising at least one clamping module for accommodating a profile or pipe material to be cut to length, said clamping module being connected with the transverse support and being adapted to be set against the saw apparatus.

15. The flying saw according to claim 14, wherein there is one of the clamping modules on each side of the saw apparatus, each of said clamping modules being connected with the transverse support and being adapted to be set against the saw apparatus.
